(19) United States
(12) Patent Application Publication
(10) Pub. No.: US 2010/0195332 A1
(43) Pub. Date: Aug. 5, 2010

(54) Decorative Lighting Strand and Method of Assembling and Installing Same

(76) Inventor: Leslie Wasem, Gray, TN (US)

Correspondence Address: FAIER & FAIER P.C., 566 W. ADAMS ST., SUITE 600, CHICAGO, IL, 60661, US

(21) Appl. No.: 12/669,029

(22) PCT Filed: Dec. 13, 2007
(86) PCT No.: PCT/US07/25587

§ 371 Date: Jan. 13, 2010

Related U.S. Application Data
(60) Provisional application No. 60/962,253, filed on Jul. 25, 2007.

(51) Int. Cl. F21S 4/00; H01R 43/00

(52) U.S. Cl. 362/249.16; 29/868

(57) ABSTRACT

A decorative lighting strand for decorating a surface having a limb with a branch extending from the limb, where the strand has a length of wire connecting a plurality of decorative bulbs and midway the strand there is a hub which can be secured on the limb so that the strand can be extended from the hub along the branch from each side of the limb, and the invention includes multiple such strands electrically connected together each of which can be arranged in a horizontal plane of the surface. The invention also includes the method of decorating a surface with one or more such lighting strands which includes the steps of attaching the hub midway the length of the strand to the limb and extending the strand along one or more branches from each side of the hub.

This invention related to a decorative lighting strand and a method of assembling and installing the same, and particularly relates to lighting stands useful in holiday decorations especially for Christmas tree and like uses.

### BACKGROUND OF THE INVENTION

Conventional lighting systems for holiday and similar decoration have many inherent problems, for example:

### Safety

The National Fire Protection Association reported that in the years 2000-2004, 1500 Christmas tree fires caused 70 deaths, 105 injuries and $84,000,000 in direct property damage, resulting from real and artificial trees. According to the US Fire Administration Department of Homeland Security, home decorations and holiday season fires resulted in 2,600 fires and loss of $930,000.000.

These losses were in great part attributable to frayed wires, bare spots, gaps in insulation, broken or cracked sockets, and excessive kinking or wear of wires before putting them up. Often these loses resulted from the use of long lengths of light strands, which frequently became tangled, particularly when stored and reused from year to year, and the lights sometimes became shorted when stored or twisted in a conventional fashion damaging the wires as they were applied both vertically and horizontally over the surface of the tree or other areas.

### Positioning and Applying of Lights

Conventionally, most holiday decorators start at the top of the tree or other surface. The long strands of lights, which are frequently tangled, are twisted to accommodate the surface on which they are applied, and usually moved circularly around the surface to be decorated and then downwardly on another level of the surface or tree. This positioning of the lights usually requires two hands to accomplish and, even then, the decorator's motions are contortions to accommodate the surface to be decorated. While most fire authorities recommend that only three strands of lights be connected, to fully decorate the surface additional strands are frequently required and they are usually connected in series or from the same outlet, sometimes even those precautions result in an overload and fire hazard, and many people connect more than three strands together.

The alignment of the lights on a strand can also be a problem, because the bulb may not be in a proper position, frequently because the twisting application of the strand on the surface. For example, if the bulb should be oriented vertically, and the wire are twisted, the bulb will certainly be canted in an undesirable position.

A conventional lighting string requires the decorator to find the beginning, middle and end of the strand, and typically, that is not only difficult but also frustrating as the strands are normally intermixed. With the strands embodying the present invention, there is always a focal point or center for decorating a surface, because the hook or hub provides a starting point for the decoration.

### Storing of the Lights

To prepare for storage, the wires must be untwisted and followed over the entire surface and that removal process can be difficult and frequently results in unseen hidden damage to the strand of lights, which is often not notices until the decoration job is completed—and then the strands must be removed, repaired or replaced and the tree or surface must be decorated again.

A great deal of damage can be done to conventional light strands when they are stored from year to year. For example, the wires and lights become twisted and often stuck to one another in an undesirable fashion, putting particular stress on the wires and bulbs and making the separating of the strand for application difficult—and sometime hazardous.

Damage caused by storage of conventional light strands may not be noticed from year to year, and if a short result, it may not be seen. Seemingly small shorts in conventional light strands are particularly hazardous when the strand is applied to an artificial tree, because a short can make the entire tree dangerous.

### Creativity of Design

The difficulties in handling and designing decorations using conventional light strands is apparent from the foregoing discussion, because such strands are usually very long, and the movement of the decorator in applying the strand around the tree is inconvenient, stressful, and difficult, and the result is often unattractive. An improper arrangement of the lights on the surface will not only be dangerous, but also may not be attractive, especially where hot or empty spots on the decorated surfaces result. These problems are often not visible until the entire surface has been trimmed, and then the job must be done anew.

### SUMMARY OF THE PRESENT INVENTION

In the present invention, a relatively short light strand, usually able to accommodate only a single branch of a trees or a single surface of the areas to be decorated only in either a selected horizontal or vertical mode, but usually not in both directions. Strands may be bundled together and joined together centrally or in a selected manner, so that they may radiate outwardly from the center of a tree or other surface. Each limb has its own light strand, and the strand is arranged so that lights may radiate outwardly from the innermost part of a tree to the outermost point of a branch. When the lights are arranged in the selected fashion, they are oriented in a desired position

The individual light bulbs in each strand of lights are connected in a series, so that in the event of a loss of a light on the strand. a shunt kicks in and permits the other lights in the strand to be lit. Additionally, each stand may carry a male plug and female socket, so that the strand may be connected to a source of power, and the strand may be connected to another strand. Furthermore, each strand may have a fuse, or circuit breaker to disconnect that strand in the event of an overload, so that there is less danger of an overload or shorting.

The center of grouped strands may be connected by a hub-like device and hook or other means for engaging a selected trunk, limb, tree surface, post or other member. This structure permits the decorator to pull the strand against a hook or the like permitting the strand to be straightened and making the bulbs oriented in an upright position. No electrical connection is required within the novel hub-like device disclosed in this application, and such a hub, as disclosed, may be provided which will not place undue strain on the strand of lights. A soft, twistable, bendable non-conductive plastic tie fastener member may also be arranged adjacent to one or more bulbs on a strand, so that the strand may be attached to a selected surface to be decorated in a selected manner.

The structure and arrangement of the light strand described makes decoration of the surface easier, and permits easy removal of a strand by disconnecting any connected lights and disconnecting the hub from the engaged limb. Once removed, the strand may be hung from a hook or stored in a box or bag for reuse the next season. The strands are not tangled and easy to extend for reuse.

When the strands are used and stored as described, optimal positioning of the lights on the selected surface is provided. The decorator may avoid cross overs to provide better placement. Wires are less noticeable, and only arranged on assigned branches so that the arrangement is cleaner, neater and more symmetrical. If a strand or single bulb must be repaired, only the affected strand or bulb is involved. If multiple colors are desired, either strands of different uniform color may be used or a single strand may be provided with different colored lamps within the strand, leaving all these decorative decisions to the decorator, depending upon the decorator's vision of the completed decoration. By use of the present invention, the decorator is not confined by the light strands, but in fact the strands embodying the present invention liberates the decorator and encourages creativity.

Where the strands of lights are to be used for a predetermined decorative purpose, as for example, to trim a tree of predetermined size and/or shape, the strands may be packaged as a kit, with strands of various lengths and light and plug arrangements, so that the top of the tree may be decorated with a shorter strand and the other parts of the tree may be decorated with strands of longer lengths, and each strand may have included male and/or female plugs for electrically joining the strands together, so that the lowest or end strand can be conveniently connected to a source of power.

### OBJECTS AND ADVANTAGES OF THE INVENTION

It is the object of the invention to provide a novel decorative lighting strand of the character described.

Another object is to provide a method of assembling and installing one or more decorative lighting strands of the character described.

Another object is to provide means for removably securing a decorative lighting strand to a limb-like surface on the object to which the strand is applied and to extend the strand vertically or horizontally from said surface.

Another object is to provide a removably securable hub or similar attachment means and multiple decorative lighting strands extending from said attachment means.

Another object is to provide directional elements on such a hub or similar attachment means for selectively directing strands of decorative lighting from said attachment means.

Another object is to orient lights on said decorative lighting strand in a predetermined selected manner.

Another object is to connect like strands of decorative lighting to one another, and to provide breaker or fuse means to prevent electrical overloads or shorts on a strand.

Another object is to provide one or more bulbs, fastener elements or ornaments on a strand of decorative lighting.

Another object is to utilize a strand of lights embodying the invention as a repair kit for pre-lit Christmas trees which require repair.

Another object is to provide strands of decorative lighting which may accommodate specialty decorations on said strand in a predetermined position or arrangements.

Another object is to provide a decorative lighting strand which is easy to produce and use in a safe and efficient manner on a Christmas tree or other surface and which can facilitate removal and storage of the decoration at a selected time, without damage to the strand or its parts.

Another object is to provide a versatile system for easy, efficient and attractive decorating of a Christmas tree or other surface in an expedient and versatile manner.

These and other objects and advantages will become more apparent as this description proceeds, taken in conjunction with the accompanying drawings.

### BRIEF DESCRIPTION OF THE DRAWINGS

In the drawings:

FIG. 1 is a top plan view of a preferred bundle of strands of lights embodying the present invention having a preferred hook and hub and male plug and female socket arrangements.

FIG. 2 is a side view of the bundle of strands of lights shown in FIG. 1.

FIG. 3 is an enlarged sectional view of the hub and hook arrangement shown in FIG. 2

FIG. 4 is a view similar to FIG. 1, except with the preferred hub arrangement shown open and without its cover.

FIG. 5 is an enlarged view of the hub arrangements shown in FIG. 4, with parts of the strands broken away.

FIG. 6 is a top plan view similar to FIG. 1, except with the wiring arranged within a molded hub arrangement.

FIG. 7 is a top plan view similar to FIG. 1, except with the hub-like structure composed of twisted plastic fasteners.

FIG. 8 is a side elevation view of the preferred hub and hook arrangement, like the arrangement shown in FIGS. 1-4.

FIG. 9 is a cross-section view of the preferred hub and hook arrangement shown in FIG. 8, taken on line 9-9 of FIG. 8.

FIG. 10 is a cross-sectional view of the preferred hub and hook arrangement shown in FIGS. 8 and 9, taken on line 10-10 of FIG. 8.

FIG. 11 is a perspective view of a modified bundle of light strands connected by a modified hook arrangement, where each strand may be moved slightly.

FIG. 12 is a perspective view of an alternative modified “S” type hook for the bundle of light strands and a part of the light strands attached to it.

FIG. 13 is a perspective view of another alternative modified bundle of light strands joined together by a molded on sleeve.

FIG. 14 is a elevation view of a trimmed tree, where the tree has been trimmed from branch to branch according to the method described in this application.

FIG. 15 is an enlarged view of the branch of the tree shown in FIG. 14 (with a permanent tie shown within the circle on a branch of FIG. 14 for securing the strand to a tree); and above and a part of this Figure is a sketch showing interwoven electric wires and a soft dielectric plastic tie for securing the wires to a branch.

FIG. 16 is an enlarged view of a branch having a modified tie arrangement set next to a light, which is a modified means for securing a lamp or bulb and its light fixture to a branch.

FIG. 16a is a view showing branches decorated according to the present invention, with multiple strands connected to the branches.

FIG. 17 is a bundle of strands having special lights or ornaments which are oriented relative to the connecting wires, so that special effects may be had where the lamps have special decorative features.

FIG. 18 is a schematic view showing two strands of lights embodying the present invention connected and secured on a pair of space apart limbs extending from and along a central post or limb, with the male plug and female socket plus of the strands engaged together and another plug connected to a source of power.

FIG. 19 is a schematic view similar to FIG. 18, except showing multiple stands of lights connected.

FIG. 20 is a circuit for a typical strand of lights embodying the present invention.

FIG. 21 is a typical plug or socket having a circuit breaker, fuse or switch which may be incorporated into the circuit, so that excessive power will cause the breaker or switch to break the line before an overload occurs.

FIG. 22 is a perspective view of part of a bundle of light strands embodying the present invention, illustrating a plug for the strand which has a resettable circuit breaker or switch, which may be reset after an overload.

FIG. 23 is an elevational view showing a shorter strand of lights which may be used to decorate the top of a tree, and also having a modified hook for engaging the limb of a tree or a similar member.

FIG. 24 are multiple views of the modified hook shown in FIG. 23, namely, depicted in FIG. 24A from one side in open condition, and similarly in FIG. 24B in closed condition, and in FIG. 24C in closed condition a right angle to FIG. 24B.

### DESCRIPTION OF PREFERRED EMBODIMENTS

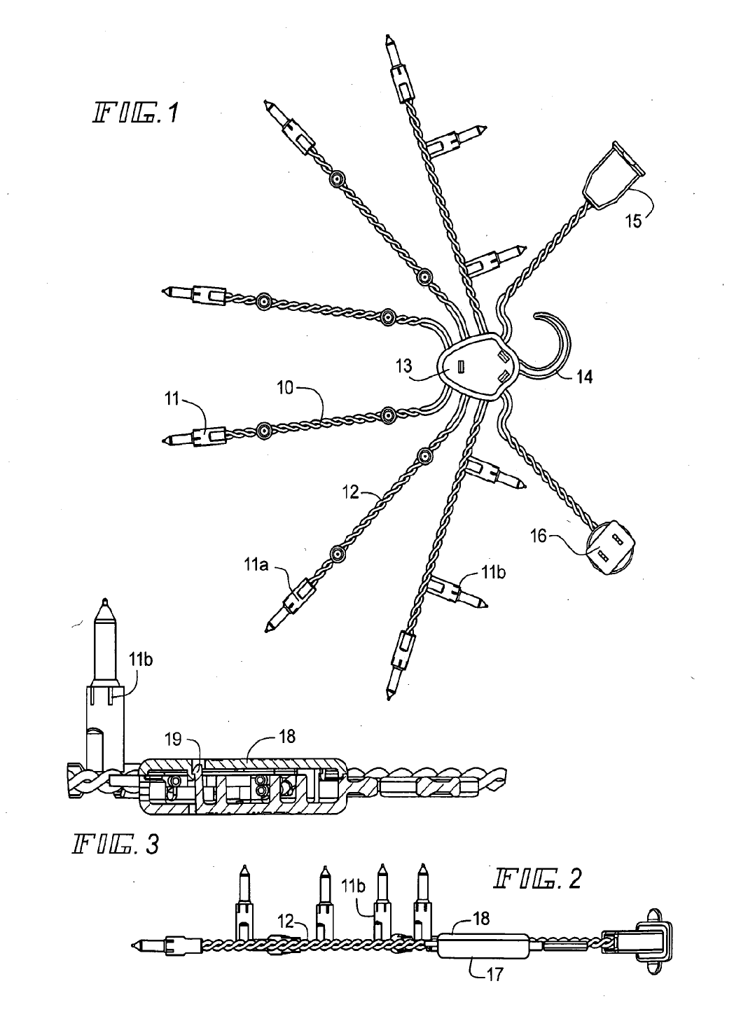

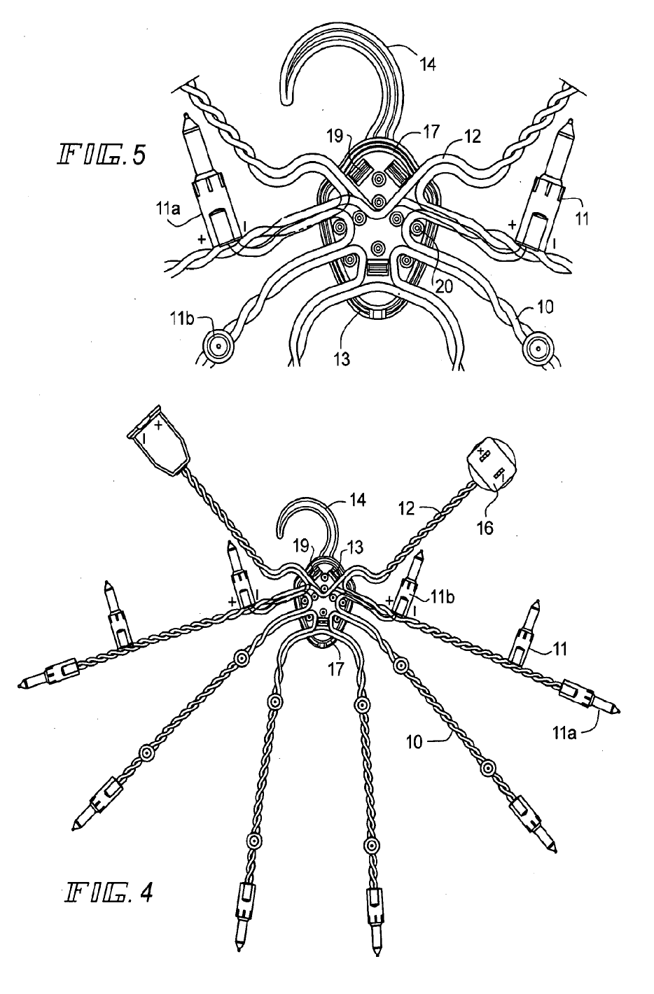

With reference to the accompanying drawings and particularly to FIGS. 1-3, a strand 10 of lamps 11 are arranged on electrical wires 12, and trained through a hub or spreader 13, which preferably may have a hook 14 for engaging a tree limb or other structure. A number of strands 10 may be bundled together through the hub 13, which pre-separates the wires. The hub may be used to stabilize the strand. A plug 15 and socket 16 for connecting the bundle of strands 10 to another bundle or strands and/or to a source of power may also be provided and arranged connected to the wires 12 through the hub 13 The lamps may be oriented relative to the wires 12 and hub 13, so that some lamps 11a are extended in the plane of the wires 12 and other lamps 11b are arranged in a plane perpendicular to the wires 12.

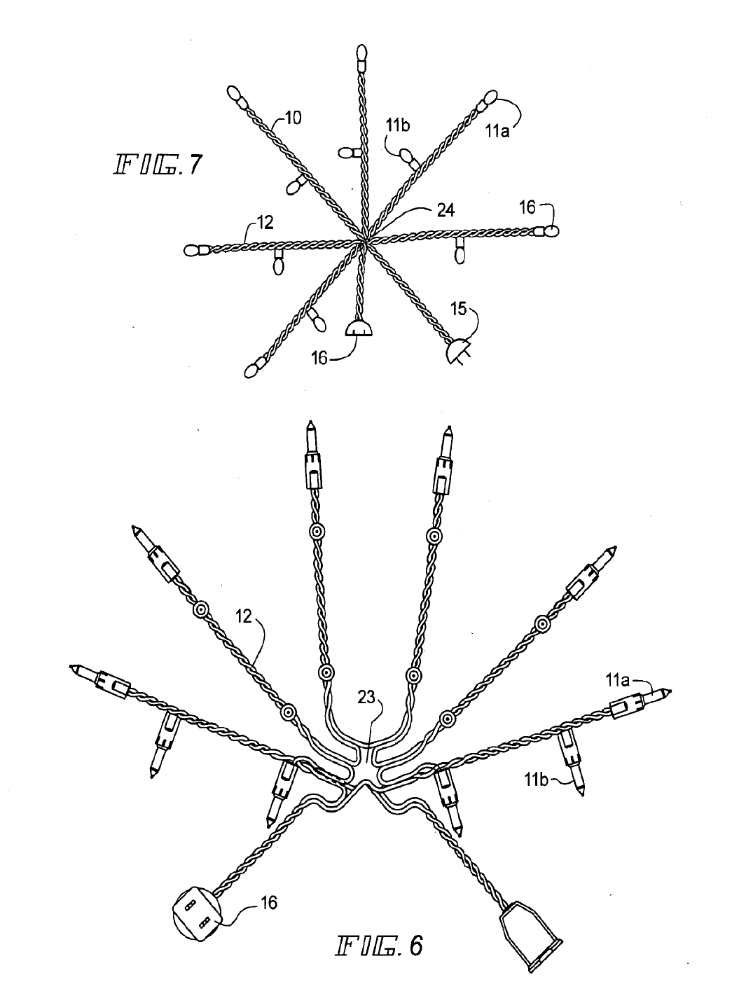

As shown in FIG. 3, the hub 13 may comprise a body 17 and a cover 18, which can be snapped together by means of barbed teeth 19. With reference to FIGS. 4 and 5, the body 17 may also have a series of upstanding ribs 20, which may be used to train and pre-separate the wires 12 of each strand 10 in a selected direction through the hub 13 in a manner so the wires 12 of each strand and those connecting the plug and socket lay in a predetermined selected position.

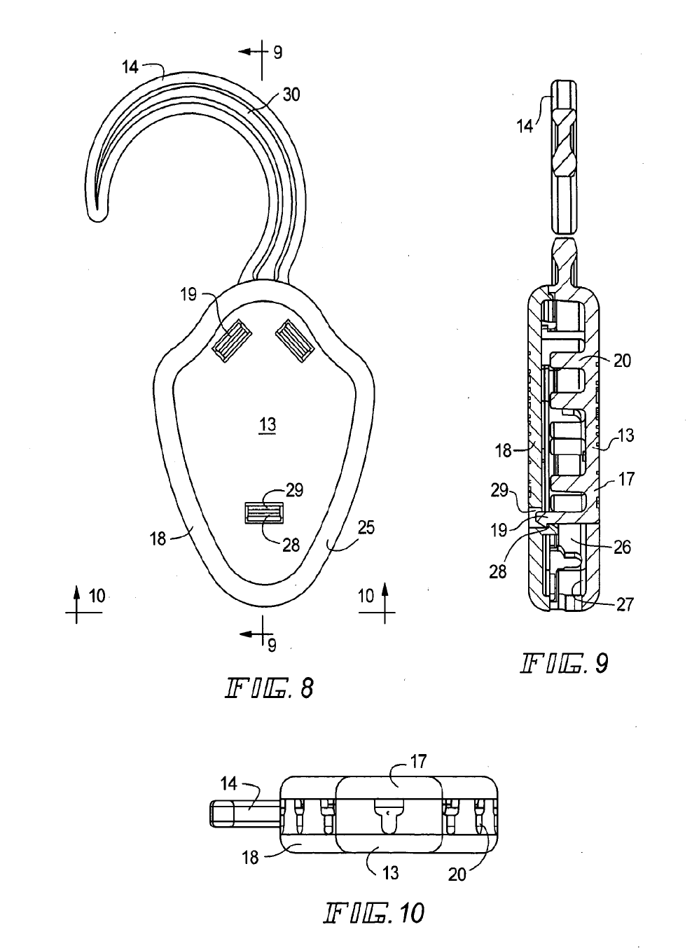

Alternatives to the hub and related structure shown in FIGS. 1-5 are depicted in FIGS. 6 and 7. In FIG. 6, the modified hub 23 comprises a molded piece which has the wires 12 secured therein. In FIG. 7, twisted plastic fastener connections 24 perform the function of the hub 13 to properly orient the wires 12 and lamps 11.

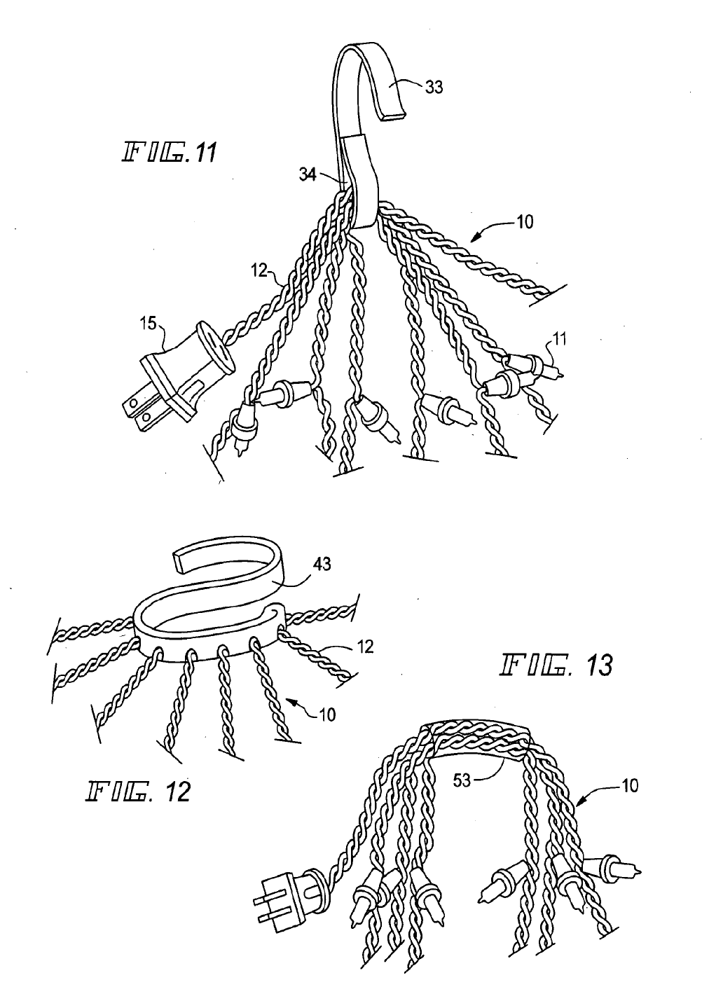

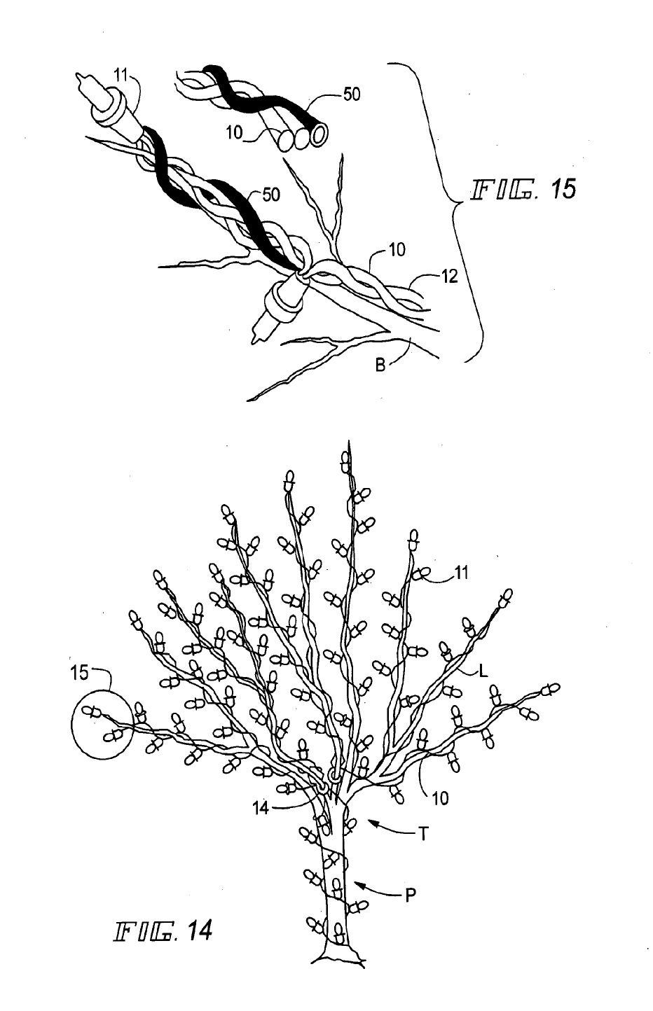

FIGS. 8-10 depict details of the preferred hub 13, preferably made of plastic dielectric insulating material. The body 17 and its cover 18 may be pendant shaped with beveled sides 25 for easy handling, and of a size to accommodate the electric wires 12 in a recess 26 formed by the body 17 and cover 18 when closed. The ribs 20 are formed on the underside 27 of the body 17 and are of a size to reach the inside wall of the cover 18, so that the wires 12 when arranged in the recess 26 will stay in a selected position. The barbed teeth 19 are upstanding on the body 17 and may be snap engaged over cooperating teeth 28 into apertures 29 in the cover 18; and preferably there are multiple sets of these members to close the body 17 and cover 18, but they may be selectively manipulated to open the recess 26 for adjustment of the wires 12. The hook 14 preferably has a longitudinally extending central reinforcement 30 which permits it to be flexible without breaking. Preferably, the hook 14 and body 17 and cover 18 are molded from thermoplastic insulating materials, so that they protect the wires, even under stress when the hook 14 is assembled on a limb L of a tree or other member.

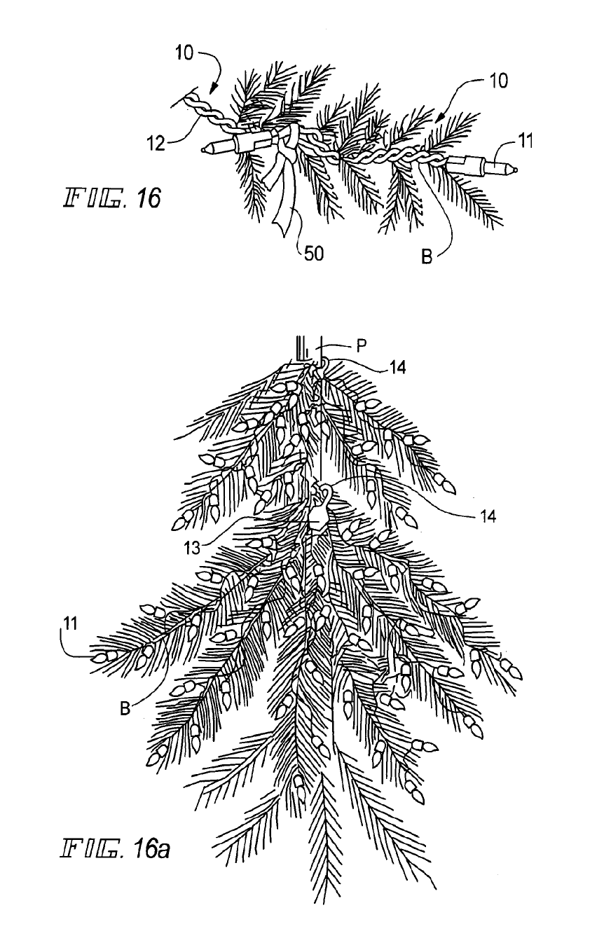

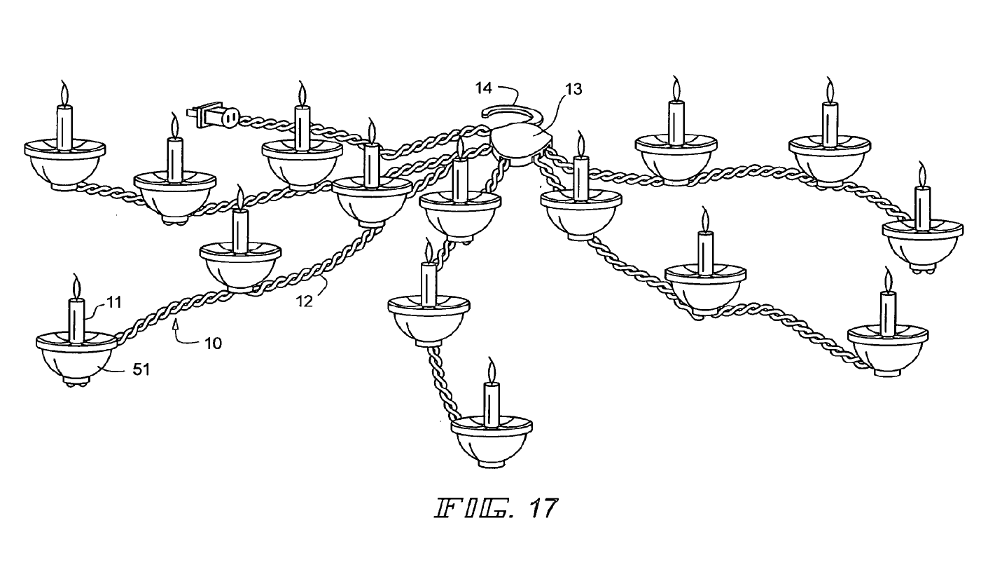

Alternate hub forms are shown in FIGS. 11-13. In FIG. 11, the hook 33 has a loop 34 through which each of the strands 10 extend; and in FIG. 12, each of the strands 10 extend from an apertured hook 43. In FIG. 13, the central restraining means for holding the bundle of strands 10 together is a sleeve 53 which is secured to or wrapped around the strands 10. In both the FIGS. 11 and 13 embodiments, during manufacture, the strands 10 may be extended on one side of the hook 33 or sleeve 53, to accommodate the length of a branch B as desired on which it may be mounted or to accomplish a design conceived of by the trimmer.

In each case, the hub or its equivalent 13 or 23 or 33 or 43 or 53 is removably secured around a limb L or post P and the strand(s) are extended outwardly substantially horizontally therefrom along a branch B or other structure. To remove the strand 10 from its limb L or post P, the hook-like member or its equivalent is merely backed up and the strand 10 is pulled from the branch B or the like. The bundle of strands 10 can be suspended by the hook-like member from a peg or rolled up for storage until its reused.

In FIGS. 14-16, a trimmed tree T is shown. With reference to FIG. 14, each strand 10 is connected by a hook 14 or the like from the trunk-like post P or a limb L and encircles the tree T outwardly from its center. Strands !0 may be connected together by means of their respective plugs and sockets, and a plug 15 at the end of a strand 10 may be exposed for connection to a source of power.

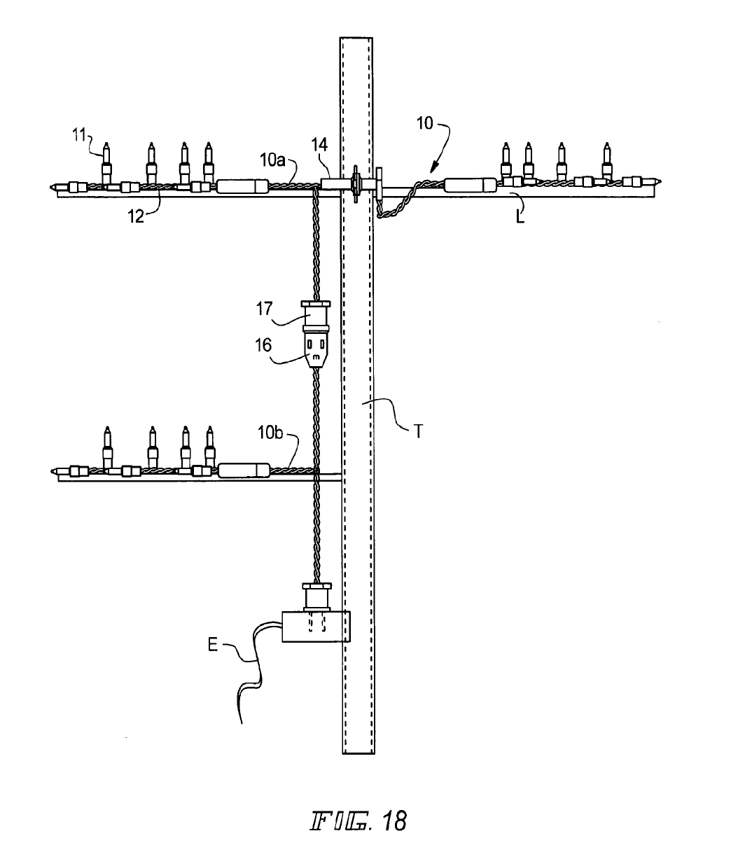

In FIG. 15, a branch B with the wires 12 of a strand 10 wound around it is shown, taken from the circle displayed in FIG. 14. Above and part of FIG. 15 is a sketch showing the electric wires 10 which may be interwoven with a soft plastic tie 50. The lamps 11 may be oriented as the decorator desires. FIG. 16 shows a modification of a strand 10 where the soft tie 50 or tape my be interconnected adjacent a lamp 11, so that the lamp may be bound and secured in a selected position on the limb L.

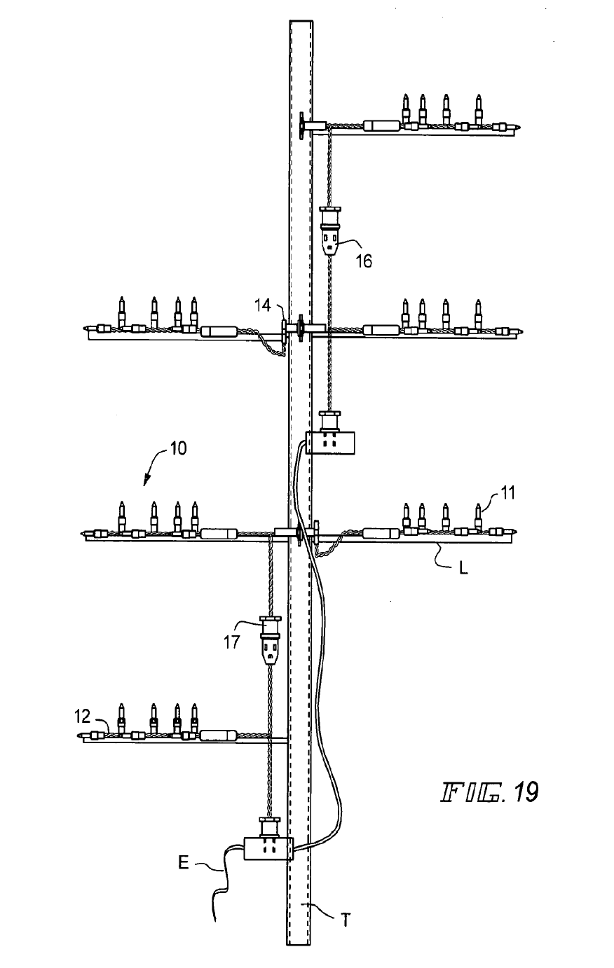

FIG. 17 illustrates another possibility using the novel structure and method disclosed in this application. The lamps 11 in this modification are arranged in lamp holders 51 or similar ornaments and are oriented to stand upward when arranged on a tree or other connected surface. In this embodiment decorative members such as small toys or dolls or other ornaments may be connected to a strand 10 and oriented like the lamp holders 51 in a selected predetermined position on the wires 12, with or without lamps. The arrangement of these ornaments may be predetermined on a strand before the strand 10 is positioned on a tree or other surface. The strand 10 need only be extended outwardly from the hub 13 and hook-like member 14 on a tree trunk T or a post to place the ornament or any special decoration in proper position.

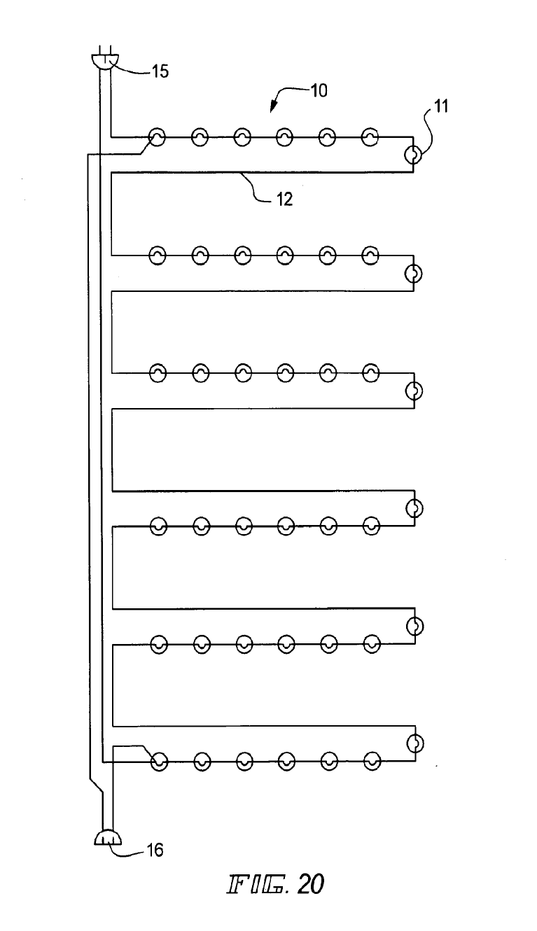

In FIGS. 18 and 19, a strand 10a is shown connected to another strand 10b by means of the socket 16 and plug 17 arrangements previously describer. The strands 10 may be extended vertically along a tree trunk T or post, and the lamps 11 are aligned upright on a limb L or branch B. Each strand 10a has a hook-like member which may be engaged on the trunk T or post, to fully extend the stand in a vertical direction. A plug on the extreme end of a strand may be connected through a extension cord E or the like to a source of power. Likewise, as shown in FIG. 19, multiple light strands 10 may be removably secured on the trunk T or post and extended outwardly horizontally from the trunk T, with one part of the strand 10 connected to trunk T. To remove the strands from the trunk T, one need only disconnect the hook-like member 14 and pull the wires 12 and connected lamps 11 toward the hook-like member 14, where they can be conveniently bundled without tangling.

A typical circuit for a strand 10 is shown in FIG. 20. Note that each strand has wires 12 which connect the lamps 11 in series and the sets in parallel. This arrangement also permits multiple strands to be connected together through each socket 15 and plug/socket 16 of successive strands.

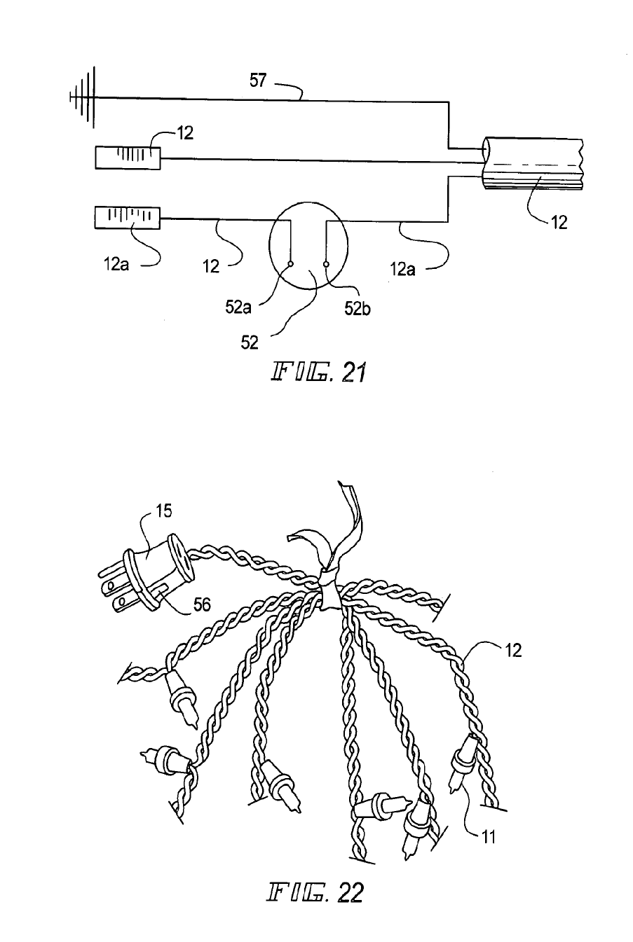

FIGS. 21 and 22 show a modified electrical arrangement where a two pole 52a and 52b circuit breaker or limit switch 52, which may have an optional ground 57. So long as the breaker or limit switch 52 is closed, power will flow through the wires 12 to the lamps 11. If there is a short or overload, the switch or circuit breaker 52 will open and power will be shut down before there is a dangerous overload or a fire hazard. The plug 15 or socket 16 can be provided with an exterior connection button 56 to the breaker or switch 52, so that a open switch can be closed by merely pressing the button once the cause of the overload or short is eliminated. Such an arrangement permits joining multiple strands 10 and the use of strands without danger of overload or fires or other electrical hazards.

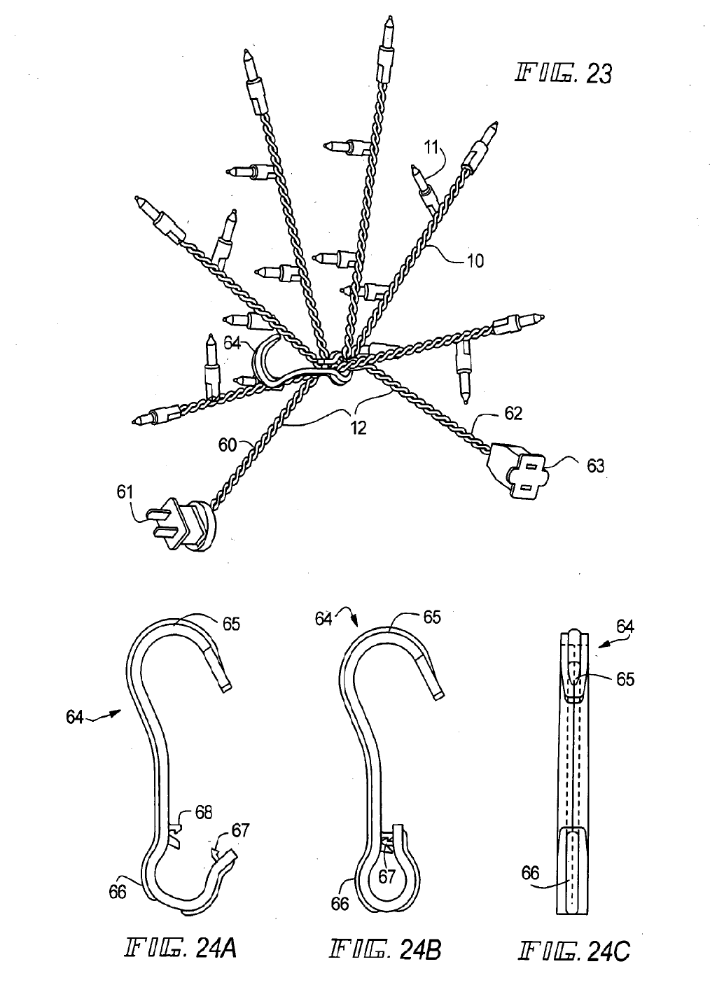

As shown in FIG. 23, the wire configuration comprises six strands 10 of lamps 11 and two lengths of connecting wires 12, one length 60 having a male plug 61 and the other length 62 having a female socket 63, and these strands are secured together at their centers by a novel modified hook 64, discussed hereafter. The strands may be assembled into kits with strands 10 of different lengths and numbers of bulbs 11 for selected different applications. For example, when trimming a typical Christmas tree, a shorter length of strand 10 can be provided for the top of the tree and longer lengths of strands 10 can be used on the girth of the tree, and this arrangement makes for a neater assembly. The plug 61 and socket 63 of a strand 10 may be trained along the central limb of the tree, instead of dangling over the circumference, and the strand on each horizontal level of the tree may be electrically connected to an adjacent level and the lower level strand maybe connected to a source of power so that the connecting wires are not visible from the periphery of the tree. The novel modified hook 64 shown in FIG. 24 is preferably molded from bendable plastic material, and comprises a hook portion 65 for connection to a limb, and a section 66 for encircling a bundle of strands 10 at any selected point along the length of strands, depending upon the surface to be decorated. This hook section 66 comprises a length of material preferably having a preformed radius, and has a barb 67 at one end and a receiving clip 68 at its other end, so that the barb may be connected to the clip for encircling a bundle of strands 10. When storing the strands 10 for the next year's use, the hook may be removed from the limb and the barb 67 may be released and removed from the clip 68, so that the strands may be conveniently stored and reused as desired, with minimum risk to the bulbs 11 and the wires 12.

Within recent years, pre-lit Christmas trees and similar pre-lit decorations have become popular, but on occasion one or more of the pre-lit lights require repair. In such an event, strands embodying the present invention may be utilized as a repair kit for such pre-lit devices. Such strands easily blend into the pre-lit device in a neat and attractive fashion.

While the novel decorative strands embodying the invention and the inventive method has been show in considerable detail and with many alternatives, it should be understood that other alternatives are possible without departing from the scope or spirit of the invention, and, accordingly, it is desired that the invention should not be limited to the exact construction, arrangement of parts and processes described.

1. A decorative lighting strand for decorating a surface having limb like members with branch members extending therefrom, said strand comprising a length of electrical wires, a plurality of decorative bulbs arranged spaced apart on and electrically connected to said wires, hub means secured on said strand midway said length of electrical wires and defining separate portions of said length, a portion of said length on opposed side of said hub means, said hub means having a surface adapted for connection on said limb-like member, and said portions each adapted to be extended from said hub means along said branch members.

2. The decorative lighting strand recited in claim 1, wherein said hub mean has hook-like structure for engaging said limb-like member.

3. The decorative lighting strand recited in claim 2, wherein said hook-like structure comprise a wire receiving member and a hook member.

4. The decorative lighting strand recited in claim 2, wherein said wire receiving member has a body and a cover.

5. The decorative lighting strand recited in claim 2, wherein said wire receiving member has means for directing said strand wire through said hub means.

6. The decorative lighting strand recited in claim 3, wherein said wire receiving member has multiple means for permitting exit of said wires from said member.

7. The decorative lighting strand recited in claim 4, wherein said cover is removably secured to said body.

8. The decorative lighting strand recited in claim 4, wherein barb means secures said cover to said body.

9. The decorative lighting strand recited in claim 4, wherein more than one set of wire are arranged in said wire receiving member and said wire receiving member has ribs for separating said one set of wires from another set of wires.

10. The decorative lighting strand recited in claim 1, wherein multiple like strands of electrical wires are secured to said hub means.

11. The decorative lighting strand recited in claim 1, wherein some of said bulbs are arranged upstanding from said wire and another of said bulbs is arranged in line axially with said wires.

12. The decorative lighting strands recited in claim 10, wherein multiple like strands have means for electrically connecting one of said strands to another of said strands.

13. The decorative lighting strands recited in claim 12, wherein said electrical connecting means comprises wires and a plug or socket connected to said wires.

14. The decorative lighting strand recited in claim 1, wherein said hub means is molded unitary with said strand.

15. The decorative lighting strand recited in claim 1, wherein said hub means comprises means to secure multiple like strands together in a bundle.

16. The decorative lighting strand recited in claim 15, wherein said securing means comprises a sleeve securing said like strands together.

17. The decorative lighting strand recited in claim 15, wherein said securing means comprises a S shaped hook securing said like strands together.

18. The decorative lighting strand recited in claim 15, wherein said securing means has a sleeve for securing said like strands together.

19. The decorative lighting strand recited in claim 1, wherein a fastener for securing said strand to a branch is arranged on said strand.

20. The decorative lighting strand recited in claim 1, wherein a lamp holder is secured on said strand between said bulb and said wire.

21. The decorative lighting strand recited in claim 1, wherein said hub means comprises a body fabricated from bendable material having an open hook at one end thereof.

22. The decorative lighting strand recited in claim 21, wherein said bendable body has means for encircling a bundle of like strands at an end thereof remote from said one end and fastening means at said remote end for closing said remote end around said bundle of like strands.

23. The decorative lighting strand recited in claim 1, wherein a circuit breaker is arranged on and electrically connected in said strand to disconnected said wires from a source of power in the event of a short or overload in said strand.

24. A method for decorating a surface with a strand of lights comprising the steps of
(1) providing a strand of lights consisting of a length of wires and a plurality of decorative lights spaced apart and electrically connected to said length of wires
(2) arranging hub means midway said length of wires to divide said length into two sections, one on different sides of said hub,
(3) attaching said hub to a selected point on said surface
(4) extending each of said sections along said surface spaced away from said selected point.

25. In the method recited in claim 24, wherein multiple like strands of lights are provided and said strands are similarly secured together by said hub means and extended along said surface.

26. In the method recited in claim 25, wherein said surface has multiple layers, one layer arranged over another layer, and multiple like sets of strands electrically connected to one another, each of said multiple like strands having hub means, one of said hub means connected to one of said layers, and the strand on one said layer being extended along said surface. of said one layer.

27. In the method recited in claim 24, wherein said hub means comprises a member of bendable material, a hook and means for securing said member around said strand, with the additional step of bending said member to removably secure said hub means around said strand.

28. In the method recited in claim 24, wherein a fastener is provided adjacent at least one of said lights, with the additional step of fastening said one light to said surface by means of said fastener.

29. In the method recited in claim 24, with the additional step of threading said wires through said hub means.

30. In the method recited in claim 26, wherein said layers of strands are connected by means of wires and an electrical socket and plug means arranged on said wires, with the additional step of electrically connecting said strands together by means of said socket and plug means.

31. In the method recited in claim 26, wherein said layers have girths of different dimensions, with the additional step of providing different lengths of strands of dimensions to suit said different dimension.

32. In the method recited in claim 24, wherein said surface has a selected point and an end point and said sections are extended along said surface from said selected point to said end point of said surface.
